(19) United States
(12) Patent Application Publication
(10) Pub. No.: US 2014/0096622 A1
(43) Pub. Date: Apr. 10, 2014

(54) FILM LAMINATE BODY FOR PRESSURE SENSITIVE FINGERPRINT SENSOR

(71) Applicant: Kohichiro Kawate, Sagamihara-city (JP)

(72) Inventor: Kohichiro Kawate, Sagamihara-city (JP)

(73) Assignee: 3M INNOVATIVE PROPERTIES COMPANY, St. Paul, MN (US)

(21) Appl. No.: 14/122,710

(22) PCT Filed: May 22, 2012
(86) PCT No.: PCT/US2012/038946

§ 371 Date: Nov. 27, 2013

(30) Foreign Application Priority Data
May 30, 2011 (JP) 2011-120763

(51) Int. Cl. G01L 5/00; G06K 9/20

(52) U.S. Cl. CPC G01L 5/00; G06K 9/209
USPC 73/862.621; 428/213

(57) ABSTRACT

To provide a film laminate body for a pressure sensitive fingerprint sensor that can provide an accurate pressure distribution corresponding to the degree of ridges and valleys of a fingerprint, and thereby can clearly recognize the shape of the fingerprint. A film laminate body for a pressure sensitive fingerprint sensor containing a base film with a first surface and a second surface, and a conductive layer formed by a dry film forming process provided on the first surface, and an elastic layer provided on the second surface, which is a side opposite the first surface of the base film, wherein the base film has a thickness of 6 μm or less, and the elastic layer has a thickness no less than the base film, and has elasticity of 10⁸ Pa or less.

### TECHNICAL FIELD

The present invention relates to a film laminate body for a pressure sensitive fingerprint sensor, and to a pressure sensitive fingerprint sensor using this film laminate body.

### BACKGROUND

One type of known fingerprint sensor is a pressure sensitive fingerprint sensor that recognizes the shape of a fingerprint by detecting a pressure distribution caused by ridges and valleys of a fingerprint when a fingertip is pressed. For example, semiconductor matrix type ultrafine surface pressure distribution sensors and matrix type surface pressure distribution detection elements as described in Japanese Unexamined Patent Application Publication No. H6-288845 and Japanese Unexamined Patent Application Publication No. H6-288846 are commonly known. Furthermore, Japanese Unexamined Patent Application Publication No. 2002-228410 discloses a pressure fingerprint sensor where a fingerprint detecting part made of a flexible film with a conductive membrane is placed on a substrate with a matrix electrode, in a configuration provided with a powder single layer coating formed by completely covering and fixing powder particles in a single particle layer on a side opposite to the conductive membrane on the flexible film.

A pressure sensitive fingerprint sensor is required to be able to obtain an accurate pressure distribution corresponding to the degree of ridges and valleys of fingerprints, and thereby be able to recognize accurately the shape of fingerprints, in order to achieve accurate fingerprint pattern recognition.

### SUMMARY

One aspect of the present invention is a film laminate body for a pressure sensitive fingerprint sensor containing a base film with a first surface and a second surface, as well as a conductive layer formed by a dry film forming process on the first surface, and an elastic layer provided on the second surface, which is a side opposite the first surface of the base film, wherein the base film has a thickness of 6 μm or less, and the elastic layer has a thickness of no less than the base film, and has an elasticity of 10⁸ Pa or less.

In one embodiment, the film laminate body for a pressure sensitive fingerprint sensor may further include a cover film on a surface side of the elastic layer opposite the base film.

In one embodiment, the elastic layer can also include a pressure sensitive adhesive. Furthermore, the base film may contain polyphenylene sulfide.

Another aspect of the present invention is a pressure sensitive fingerprint sensor including a substrate with matrix electrodes, and a film laminate body for the pressure sensitive fingerprint sensor placed on this substrate so as to contact the matrix electrodes and the conductive layer.

The present invention can provide a film laminate body for a pressure sensitive fingerprint sensor that can obtain an accurate pressure distribution corresponding to the degree of ridges and valleys of a fingerprint and thereby can clearly recognize the shape of the fingerprint, and that can be manufactured inexpensively, and that can also provide a pressure sensitive fingerprint sensor provided with this film laminate body that can clearly recognize the shape of the fingerprint.

### BRIEF DESCRIPTION OF THE DRAWINGS

FIG. 1 is a diagram schematically illustrating a cross-section configuration of the film laminate body for a pressure sensitive fingerprint sensor of a preferred embodiment.

FIG. 2 is a diagram schematically illustrating a condition of performing fingerprint recognition using a pressure sensitive fingerprint sensor 100.

FIGS. 3a-3c are diagrams illustrating results obtained by a fingerprint recognition device using a pressure sensitive fingerprint sensor provided with films 1 through 3 respectively according to an example of the present invention.

FIGS. 4a-4b are diagrams illustrating results obtained by a fingerprint recognition device using a pressure sensitive fingerprint sensor provided with films 4 and 5 respectively according to an example of the present invention.

FIGS. 5a-5c are diagrams illustrating results obtained by a fingerprint recognition device using a pressure sensitive fingerprint sensor provided with films 6 through 8 respectively according to a comparative example.

### DETAILED DESCRIPTION

Preferred embodiments of the present invention are described below in detail while referring to the drawings, but the present invention is not restricted to the following embodiments. Note that in the following descriptions, identical or similar constituents are assigned the same code and a duplicate description is omitted.

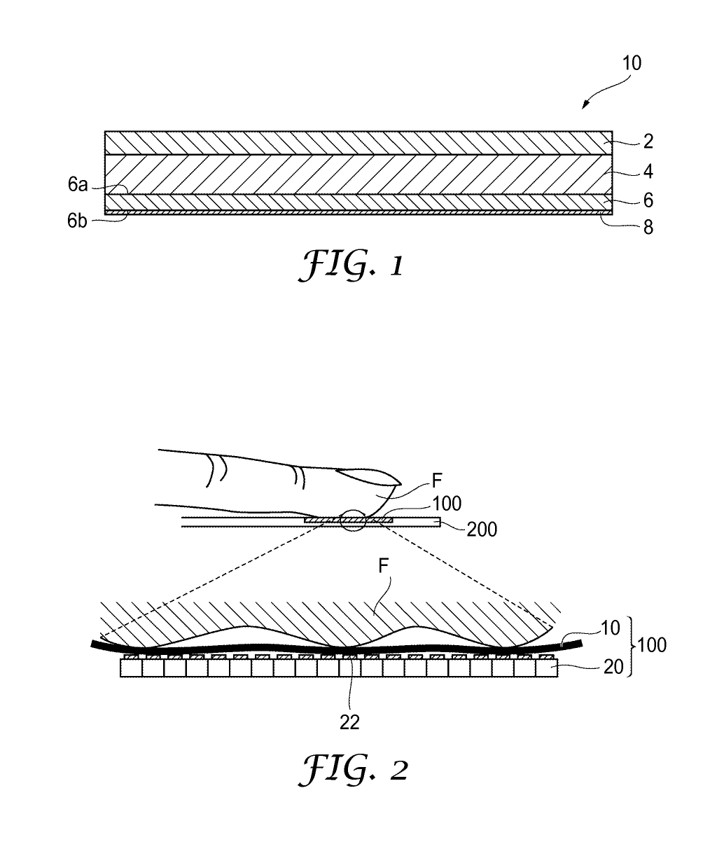

FIG. 1 is a diagram schematically illustrating a cross-section configuration of a film laminate body for a pressure sensitive fingerprint sensor of a preferred embodiment. A film laminate body for a pressure sensitive fingerprint sensor 10 (hereinafter abbreviated as “film laminate body 10”) illustrated in FIG. 1 has a structure with a conductive layer 8, a base film 6, an elastic layer 4, and a cover film 2, laminated in this order.

The film laminate body 10 can be provided on a substrate with matrix electrodes as described below, and used in a pressure sensitive fingerprint sensor. In this case, the film laminate body 10 is configured such that the conductive layer 8 faces a substrate side, and is pressed down by a finger on a cover film 2 side.

The base film 6 has a first surface 6a and a second surface 6b that are mutually facing. A thickness of the base film 6 (distance from the first surface 6a to the second surface 6b) is 6 μm or less. If the thickness of the base film 6 is 6 μm or less, the film laminate body 10 will be able to favorably deform to match the deformation of the elastic layer 4 and the cover film 2 generated along ridges and valleys of a fingerprint, when the film laminate body 10 is pressed by a finger. As a result, pressure distribution caused by the ridges and valleys of the fingerprint can be accurately transferred to a conductive layer 8 side. In order to obtain more favorable results such as these, the thickness of the base film 6 is preferably 5 μm or less, and even more preferably 2 μm or less. However, if the base film 6 is too thin, there is a possibility that breaking or the like will easily occur, and therefore the thickness of the base film 6 is preferably 1 μm or higher.

The conductive layer 8 is provided on the first surface 6a of the base film 6. The conductive layer 8 is formed by a dry film forming process on the first surface 6a of the base film 6. Herein, the dry film forming process is a process that forms a film on the surface of an object either in a gas or in a vacuum, and examples include film-forming processes that use a vapor deposition method or a sputtering method.

A thickness of the conductive layer 8 is a thickness that can sufficiently deform together with deformation of the cover film 2, the elastic layer 4, and the base film 6, when the film laminate body 10 is pressed by a finger. The conductive layer 8 is formed by a dry film forming process on the first surface 6a of the base film 6, and therefore can have a preferable thickness if formed using normal dry film forming process conditions. For example, the thickness of the conductive layer 8 is preferably sufficiently thinner than the base film, more preferably from 1 to 100 nm, and even more preferably from 10 to 50 nm. The base film 6 can be made from a material with properties (heat resistance and strength) that can form the conductive layer 8 by a dry film forming process, and is preferably made from a resin material with these properties. The base film 6 is preferably a resin film made from a resin material, and can be a resin film made from polyphenylene sulfide, polyamide, polyester, or the like, for example. Of these, polyphenylene sulfide (PPS) can demonstrate high resistance and strength even when the thickness is 6 μm or less. Therefore, the conductive layer 8 can be formed by a dry film forming process, and can demonstrate high strength when used in the film laminate body 10, and therefore polyphenylene sulfide is preferable as the material for the base film 6.

A material of the conductive layer 8 can be formed by a dry film forming process, and should be able to demonstrate conductivity when the conductive layer 8 is formed. The material of the conductive layer 8 can be an oxide material with conductivity such as ITO or the like, or a metal material with excellent conductivity such as gold, for example.

The elastic layer 4 is provided on the second surface 6b of the base film 6. The elastic layer 4 has a thickness that is at least thicker than the thickness of the base film 6. The thickness of the elastic layer 4 is preferably from 6 to 20 μm, more preferably from 7 to 15 μm. If the thickness is at a preferable level, the base film 6 can be favorably supported, and there is a tendency that peeling and deformation of the base film 6 can easily be prevented. Furthermore, even if pressing and releasing by finger is repeatedly performed, the original shape can easily be maintained, and therefore there is a tendency that durability of the pressure sensitive fingerprint sensor will be enhanced.

The elastic layer 4 is an elastic body. Herein, the elastic body is an object that is acted on by recovery forces so as to recover deformation when deformation has been generated by applying a force. The elastic layer 4 is an elastic body, and therefore the film laminate body 10 can repeatedly deform and return to the original shape along the ridges and valleys of a fingerprint in conjunction with pressing and releasing by a finger from the cover film 2 side.

Furthermore, an elasticity of the elastic layer 4 is 10⁸ Pa. If the elasticity of the elastic layer 4 is 10⁸ or less, deformation of the elastic layer 4 will occur more easily than deformation of the ridges and valleys of a fingerprint when the film laminate body 10 is pressed by a finger from the cover film 2 side. Therefore, flattening of the ridges and valleys of a fingerprint will be minimal when pressed by a finger, and therefore the original ridges and valleys of a fingerprint (prior to pressing) will easily be reflected by the change in shape of the film laminate body 10 along the ridges and valleys of a fingerprint created by pressing a finger. As a result, accurate fingerprint recognition can be performed if this film laminate body 10 is applied to a pressure sensitive fingerprint sensor.

From the perspective of more preferably achieving these results, the elasticity of the elastic layer 4 is preferably 5×10⁷ Pa or less, and more preferably 10⁷ Pa or less. However, if the elasticity of the elastic layer 4 is too small, deformation due to factors other than pressing by finger can easily occur, and there is a possibility that performing accurate fingerprint recognition will be difficult. Therefore, the elasticity of the elastic layer 4 is preferably 10³ Pa or less, more preferably 10⁴ Pa or less.

The elasticity of the elastic layer 4 can be measured, for example, by measuring the change in thickness when only the elastic layer 4 is taken, and a load is applied in a direction perpendicular to the planar direction. In other words, if an initial thickness L₀ when a load K per unit area is applied is L, the elasticity is expressed by K/(1−L/L₀). Note that, as described below, the elastic layer 4 is not necessarily made of a single material, and can have a laminate structure of a plurality of materials. For example, if the elastic layer 4 has a laminate configuration with a thickness ratio such that materials 1, 2, 3, 4, . . . having an elasticity of E₁, E₂, E₃, E₄, . . . have a thickness of x₁, x₂, x₃, x₄, . . . with regards to a total thickness of the elastic layer 4 (where x₁+x₂+x₃+x₄ +. . . =1), an elasticity E of the bulk body can similarly be measured by the aforementioned method. In this case, the relationship between the elasticity of the bulk body and the elasticity of each of the components (E₁, E₂, E₃, E₄. . . ) can be described by the following formula.

1/E=x₁/E₁+x₂/E₂+x₃/E₃+x₄/E₄+

A material of the elastic layer 4 is a material such that the elastic layer 4 is an elastic body and has the elasticity specified above. Furthermore, a material that has adhesion to the base film 6 and the cover film 2 is more preferable. The material of the elastic layer 4 is preferably a pressure sensitive adhesive (PSA). For example, acrylic PSA, urethane PSA, silicone PSA, rubber PSA, and the like can be used, but of these, acrylic PSA is preferable.

The cover film 2 is provided on a surface side of the elastic layer 4 opposite the base film. By providing the cover film 2, damage to the elastic layer 4 by contact with the finger or the like is minimized, and thus there is a tendency for the durability of the film laminate body 10 and the pressure sensitive fingerprint sensor provided therewith to be enhanced. Furthermore, for cases where the elastic layer 4 has adhesion, a tack-free feel during use can be achieved, and in addition, adhesion of foreign matter and a reduction of the recognition sensitivity can be prevented by providing a tack-free cover film 2.

A thickness of the cover film 2 is preferably a thickness that can sufficiently transfer the shape of ridges and valleys to the elastic layer 4, and can deform along the ridges and valleys of a fingerprint when pressed by a finger. For example, the thickness of the cover film 2 is preferably thinner than at least the elastic layer 4, more preferably is from 5 to 15 μm, and even more preferably is from 6 to 12 μm.

As described above, a material of the cover film 2 is not particularly restricted so long as the material has properties to be able to deform along the ridges and valleys of a fingerprint when pressed. For example, a plastic material can be suggested, but more specifically, polyester or polyolefins such as polyethylene or polypropylene can be suggested.

The film laminate body 10 can be manufactured by suitably laminating each of the aforementioned layers. For example, the film laminate body 10 can be manufactured by first preparing the base film 6 with the conductive layer 8 formed on the surface by a dry film forming process and the cover film 2 with the elastic layer 4 formed on the surface, and then laminating these together such that the base film 6 and the elastic layer 4 are in contact.

The base film 6 with the conductive layer 8 formed on the surface can be manufactured by forming the conductive layer 8 on the base film 6 by a dry process such as a vapor deposition method, sputtering method, or the like. Furthermore, the cover film 2 with the elastic layer 4 formed on the surface can be formed by a solution coating process where a solution containing the component materials of the elastic layer 4 dissolved in a solvent is applied onto the surface of the cover film 2 and then dried. Furthermore, the film laminate body 10 can be obtained by laminating the base film 6 with the conductive layer 8 formed on the surface and the cover film 2 with the elastic layer 4 formed on the surface, by pressure bonding these films together using a laminator or the like.

However, with the present embodiment, the thickness of the base film 6 is 6 μm or less, but if the base film 6 is made of a resin material in particular, the thickness will be much thinner than a normal plastic film. Therefore, when pressure bonding the films as described above, the base film 6 with the conductive layer 8 formed on the surface will not have sufficient rigidity and strength, handling will be difficult, and there is a possibility that the film will break during pressure bonding.

Therefore, in a preferred embodiment, a support film with sufficient strength, such as PET or the like is provided on the conductive layer 8 side of the base film 6 with the conductive layer 8 formed on the surface, and thus the aforementioned pressure bonding can be performed in a condition of a laminate body. Therefore, the thin base film 6 is supported by a supporting film and the laminate body will achieve sufficient strength, and therefore when pressure bonding, the handling properties can be enhanced, and breaking or the like of the thin base film 6 can be suppressed. After pressure bonding, the film laminate body 10 of the preferred embodiment can be obtained by peeling away the support film. Note that the support film can be attached to the conductive layer 8 with a pressure sensitive adhesive layer such as PSA interposed therebetween, and in this case, the support film and the pressure sensitive adhesive layer can be peeled apart after pressure bonding.

The film laminate body 10 of the present embodiment has the aforementioned configuration, and is formed by the manufacturing method described above, but the configuration and manufacturing method of the film laminate body are not necessarily restricted to this embodiment.

In other words, with the aforementioned embodiment, the elastic layer 4 was a single layer formed from only one type of material, but elastic layer 4 does not necessarily need to have only one layer, and can be made by laminating a plurality of layers of different materials or properties. For example, the elastic layer 4 may have a laminate configuration where the adhesive layer for adhering the base film 6 and the cover film 2 is provided on both sides of a layer made from a specific elastic body. In this case, the elastic layer 4 made from a plurality of layers is an elastic body in all of the layers, has elasticity of 10⁸ Pa or lower, and satisfies the aforementioned thickness conditions. Furthermore, in this case, the measurement method for elasticity can be applied to the elastic layer 4 made of a plurality of layers.

Similarly, the base film 6 and the cover film 2 do not necessarily need to be a single layer made from only one type of material, and can be made by laminating a plurality of layers. In this case as well, the base film 6 and the cover film 2 made the plurality of layers may have the preferred thickness or the like as an overall total thickness.

Furthermore, the film laminate body does not necessarily have a cover film. For example, if the elastic layer 4 itself has sufficient durability and has properties such that the feel during use is not inferior, the film laminate body can sufficiently function as a pressure sensitive fingerprint sensor even without having a cover film.

Furthermore, the film laminate body 10 can be manufactured by a method other than the aforementioned method. For example, the film laminate body 10 can be formed by successively laminating the elastic layer 4 and the cover film 2 on the base film 6, which is provided with the conductive layer 8 by a dry film forming process, or on the base film 6 of a laminate body where the base film 6 is supported by a supporting film. Furthermore, the film laminate body 10 can be manufactured by separately forming a film for forming the elastic layer 4, overlaying the base film 6 provided with the conductive layer 8, (or with a laminate body also provided with a supporting film), the film for forming the elastic layer 4, and the cover film, and then pressure bonding these layers together.

Next, an example of a case where the film laminate body 10 of the aforementioned preferred embodiment is used in a pressure sensitive fingerprint sensor is described. FIG. 2 is a diagram schematically illustrating a condition of performing fingerprint recognition using a pressure sensitive fingerprint sensor 100 that uses the film laminate body 10. In FIG. 2, the upper side illustrates a condition where a finger F presses on the pressure sensitive fingerprint sensor 100, and the lower side illustrates an enlarged contact part between the finger F and the pressure sensitive fingerprint sensor 100.

As illustrated in FIG. 2, the pressure sensitive fingerprint sensor 100 is provided on a predetermined fingerprint recognition device 200. By pressing on the pressure sensitive fingerprint sensor 100 with a finger F, a pattern of a fingerprint on the finger F can be recognized.

The pressure sensitive fingerprint sensor 100 has a configuration that provides a film laminate body 10 on a substrate 20. Herein, a plurality of matrix electrodes 22 is provided on the film laminate body 10 of the substrate 20. These matrix electrodes 22 are arranged in a matrix at a predetermined interval on the substrate 20. The matrix electrodes 22 are, for example, output electrodes for switching elements not illustrated in the drawings. Note that the film laminate body 10 has the same structure as that illustrated in FIG. 1, and therefore discussion of the detailed construction is omitted for FIG. 2.

In the pressure sensitive fingerprint sensor 100, the film laminate body 10 is provided such that the conductive layer 8 faces the substrate 20. The film laminate body 10 and the substrate 20 are arranged to be separated such that the conductive layer 8 and the matrix electrodes 22 are not in contact, in the condition where the film laminate body 10 is not pressed by the finger or the like.

As illustrated in FIG. 2, when the pressure sensitive fingerprint sensor 100 is pressed by a finger F, the film laminate body 100 deforms along the ridge and valley shapes of the fingerprint. Therefore, the conductive layer 8 will have regions that contact with the matrix electrodes 22, and regions that do not contact, corresponding to the ridges and valleys of the fingerprint. A voltage between the conductive layer 8 and the matrix electrodes 22 will vary depending on the degree of contact, and therefore a voltage distribution corresponding to the ridges and valleys of the fingerprint can be obtained by measuring the voltage of each region where the matrix electrode is provided. The pattern of the fingerprint of the finger F can be recognized based on this voltage distribution.

The pressure sensitive fingerprint sensor 100 has the film laminate body 10 of the aforementioned embodiment, and therefore can demonstrate the following excellent effects.

In other words, first, the film laminate body 10 is an elastic body and has the elastic layer 4 with the aforementioned specific elasticity, and therefore when pressed by a finger F, ridges and valleys of the fingerprint will not be excessively flattened, and the film laminate body 10 can be deformed to match the ridges and valleys. Furthermore, the base film 6 in the film laminate body 10 has a thickness of 6 μm or less, and therefore can sufficiently deform to track the elastic layer 4 that is deformed by pressing by a finger F, and can accurately transfer the ridges and valleys of the fingerprint as ridge and valley shapes on the conductive layer 8 side. As a result, contact between the conductive layer 8 of the film laminate body 10 and the matrix electrodes 22 on the substrate 20 can be made to accurately correspond to the level of the ridges and valleys inherent in the fingerprint, and as a result, highly accurate fingerprint recognition can be performed using the pressure sensitive fingerprint sensor 100.

### EXAMPLES

Examples of the present invention are described below in further detail below, but the present invention is not limited to these examples.

### Fabricating the Pressure Sensitive Fingerprint Sensor

First, a fingerprint sensor (BLP-100, manufactured by BMF Corporation) was prepared. The film provided on the surface of the fingerprint sensor was replaced with the following types of films 1 through 8, and then various types of pressure sensitive fingerprint sensors were fabricated.

### Film 1: Film Laminate Body for Pressure Sensitive Fingerprint Sensor of Working Example

A film laminate body was prepared by laminating, in order, a base film, which was made of a polyphenylene sulfide (PPS) film (Trelina (registered trademark), product of Toray) with a thickness of 2 μm and a metal film with a thickness of 200 to 500 Angstroms that was formed on the surface by sputtering, an elastic layer made of acrylic PSA with a thickness of 10 μm, and a cover film made of a polyethylene terephthalate (PET) film with a thickness of 6 μm.

### Film 2: Film Laminate Body for Pressure Sensitive Fingerprint Sensor of Working Example

A film laminate body was prepared by laminating, in order, a base film, which was made of a PPS film (Trelina (registered trademark), product of Toray) with a thickness of 2 μm and a metal film with a thickness of 200 to 500 Angstroms that was formed on the surface by sputtering, an elastic layer made of acrylic PSA with a thickness of 25 μm, and a cover film made of a PET film with a thickness of 6 μm.

### Film 3: Film Laminate Body for Pressure Sensitive Fingerprint Sensor of Working Example

A film laminate body was prepared by laminating, in order, a base film, which was made of a PPS film (Trelina (registered trademark), product of Toray) with a thickness of 2 μm and a metal film with a thickness of 200 to 500 Angstroms that was formed on the surface by sputtering, an elastic layer made of acrylic PSA with a thickness of 50 μm, and a cover film made of a PET film with a thickness of 6 μm.

### Film 4: Film Laminate Body for Pressure Sensitive Fingerprint Sensor of Working Example

A film laminate body was prepared by laminating, in order, a base film, which was made of a PET film with a thickness of 6 μm and a metal film with a thickness of 200 to 500 Angstroms that was formed on the surface by sputtering, an elastic layer made of acrylic PSA with a thickness of 10 μm, and a cover film made of a PET film with a thickness of 6 μm.

### Film 5: Film Laminate Body for Pressure Sensitive Fingerprint Sensor of Working Example

A film laminate body was prepared by laminating, in order, a base film, which was made of a PET film with a thickness of 6 μm and a metal film with a thickness of 200 to 500 Angstroms that was formed on the surface by sputtering, an elastic layer made of acrylic PSA with a thickness of 25 μm, and a cover film made of a PET film with a thickness of 6 μm.

### Film 6: Comparative Example

A film containing only a PPS film (Trelina (registered trademark) with a thickness of 2 μm.

### Film 7: Comparative Example

A film containing only a PET film with a thickness of 6 μm.

### Film 8: Comparative Example

A film containing only a PET film with a thickness of 9 μm.

### Fabrication and Evaluation of Fingerprint Recognition Device

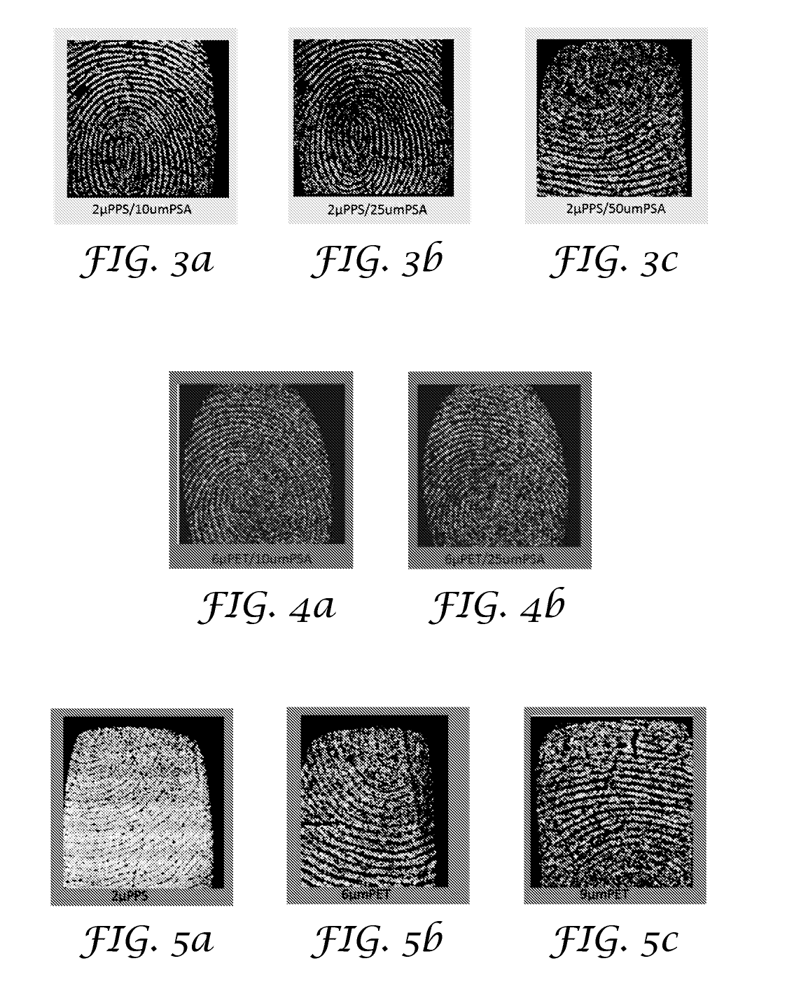

The pressure sensitive fingerprint sensors containing the aforementioned films 1 through 8 were each connected to a controller IC (BCT-100, product of BMF Corporation) to form various types of fingerprint recognition devices. Furthermore, fingerprint recognition was performed using the fingerprint recognition devices. The results of an imaging of the shape of the fingerprint recognized by each fingerprint recognition device are illustrated in FIG. 3 through FIG. 5. FIG. 3A through FIG. 3C show the results obtained from a fingerprint recognition device that uses the pressure sensitive fingerprint sensor having films 1 through 3 according to the working examples of the present invention, FIG. 4A and FIG. 4B show the results obtained from a fingerprint recognition device that uses the pressure sensitive fingerprint sensor having films 4 and 5 according to the working examples of the present invention, and FIG. 5A through FIG. 5C show the results obtained from a fingerprint recognition device that uses the pressure sensitive fingerprint sensor having films 6 through 8 according to the comparative examples.

As illustrated in FIG. 3 through FIG. 5, it is recognized that when using films 1 through 5 which are film laminate bodies for pressure sensitive fingerprint sensors according to working examples of the present invention, an image illustrating the shape of a clear fingerprint is obtained, and the shape of the fingerprint can be clearly recognized, as compared to when using films 6 through 8 (comparative examples) which are simply plastic films.

1. A film laminate body for a pressure sensitive fingerprint sensor, comprising:
a base film having a first and a second surface, as well as a conductive layer formed by a dry film forming process provided on the first surface; and
an elastic layer provided on the second surface, which is a side opposite the first surface of the base film; wherein:
the base film has a thickness of 6 μm or less; and
the elastic layer has a thickness of no less than the thickness of the base layer, and an elasticity of 10⁸ Pa or less.

2. The film laminate body for a pressure sensitive fingerprint sensor according to claim 1, further comprising a cover film on a surface side of the elastic layer opposite the base film.

3. The film laminate body for a pressure sensitive fingerprint sensor according to claim 1, further comprising a pressure sensitive adhesive.

4. The film laminate body for a pressure sensitive fingerprint sensor according to claim 1, wherein the base film contains polyphenylene sulfide.

5. A pressure sensitive fingerprint sensor, comprising:
a substrate having matrix electrodes; and
a film laminate body for a pressure sensitive fingerprint sensor as described in claim 1, arranged on the substrate such that the matrix electrodes and the conductive layer are facing each other.
